(19) United States
(12) Patent Application Publication
(10) Pub. No.: US 2007/0254725 A1
(43) Pub. Date: Nov. 1, 2007

(54) CELLULAR TELEPHONE CABLE ASSEMBLY

(76) Inventor: Richard C. Smith, Costa Mesa, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/696,987

(22) Filed: Apr. 5, 2007

Related U.S. Application Data
(63) Continuation-in-part of application No. 11/618,344, filed on Dec. 29, 2006.
Application No. 11/618,344 is a continuation-in-part of application No. 11/411,314, filed on Apr. 26, 2006.

(51) Int. Cl. H04M 1/00

(52) U.S. Cl. 455/569.1

(57) ABSTRACT

A cable assembly for personal electronic devices such as cellular telephones and music players is disclosed. The cable assembly can comprise either one or two earpieces, each of which is configured to be received into the conchae of a user's ear. The earpiece(s) can be configured so as to be held in place by at least one anatomical structure of the conchae. A speaker can be in acoustic communication with each earpiece. A cable can be configured to communicate a signal representative of sound from the personal electronic device to each earpiece. A microphone can be permanently attached or removably attachable to the cable to facilitate use with a cellular telephone. The cable assembly can facilitate hands free operation of a cellular telephone and can facilitate listening to a music player.

### RELATED APPLICATIONS

This patent application is a continuation-in-part (CIP) patent application of U.S. Ser. No. 11/618,344, filed on Dec. 29, 2006, entitled RADIO CABLE ASSEMBLY (docket no. M-16316 US) and is a continuation-in-part (CIP) patent application of U.S. Ser. No. 11/411,314, filed on Apr. 26, 2006, entitled EARPIECE WITH EXTENSION (docket no. M-15744-1P US), the entire contents of both of which are hereby expressly incorporated by reference.

### TECHNICAL FIELD

The present invention relates generally to electronics. The present invention relates more particularly to a microphone and/or earpiece cable assembly for personal electronic devices such as cellular telephones, music players, and the like.

### BACKGROUND

Cellular telephones are well known. Cellular telephones are commonly used for both business and personal communications. As the cost of cellular telephones continues to drop, their use is becoming increasingly pervasive.

Cellular telephones have built-in microphones and speakers. Typically, a cellular telephone is used by holding it up to the user's head to facilitate use of the built-in microphone and speaker. Such hand held use is common while driving. However, there is growing concern that such use of cellular telephones while driving is dangerous. Indeed, the number of accidents blamed on cellular telephone use is growing.

In response to the concern regarding cellular telephone use while driving, there is an emerging trend among governments to legislate against driving while using a hand held cellular telephone. As a result, the use of hands free cellular telephones is increasing.

Hands free cellular telephone operation can be achieved by using the cellular telephone as a speaker phone, by wired connection of an external microphone and speaker to the cellular telephone, or by wireless connection of an external microphone and speaker to the cellular telephone.

Some cellular telephones can be operated as speaker phones. That is, the sound volume provided by the speaker can be increased so that the user can hear communications without holding the cellular telephone to the user's head. The microphone can pick up the user's voice even when the cellular telephone is used in this manner.

However, the volume of cellular telephones used in this manner is often less than desirable. Further, since the microphone is positioned away the user's mouth, it may pick up extraneous noise that interferes with the conversation. Further, both sides of such conversations are readily overheard by third parties.

A wired connection, provided by a cable assembly, can be used to electrically connect an external microphone and speaker to a cellular telephone. For example, the cable assembly may connect a headset to the cellular telephone. The headset can have an earpiece that contains the speaker and a boom that contains the microphone. In this manner, the cellular telephone may be used without holding it to the user's head. However, contemporary headsets are comparatively bulky, cumbersome, and inconvenient. They are subject to slipping away from their desired positions.

Wireless connections, such as those provided by Bluetooth® headsets, are preferred by some users. However, such wireless connections suffer from inherent deficiencies. For example, wireless connections are susceptible to radio frequency interference, making them less reliable than wired connections. They are also subject to unauthorized interception, making them less secure than wired connections.

The hands free convenience of wired connections makes them desirable in situations other than driving. For example, such operation of cellular telephones while walking, working, and engaging in a wide variety of other activities is common.

Music players, such as MP3 players and iPods®, are also rapidly increasing in popularity. Music players are commonly listened to via the use of an earpiece. However, contemporary earpieces for both cellular telephones and music players tend to be uncomfortable, insecure in their placement in the ear, and insufficiently durable for the frequent use that they typically endure.

In view of the foregoing, it is desirable to provide a device for facilitating hands free cellular telephone operation wherein the speaker can readily be heard, picking up extraneous noise by the microphone is substantially mitigated, third parties cannot readily hear both sides of a conversation, susceptibility to radio frequency interference is substantially mitigated, and security is enhanced, particularly wherein the device is less bulky, cumbersome, and inconvenient than contemporary headsets. It is also desirable to provide an earpiece and cable assembly for use with personal electronic devices such as music players, wherein the earpiece is comfortable, secure in its placement in the ear, and sufficiently durable for the frequent use.

### BRIEF SUMMARY

A cable assembly for personal electronic devices is disclosed. The cable assembly can be used with such personal electronic devices as cellular telephones, radios (both one way and two way radios), hearing aids, MP3 players, iPods®, pocket computers, laptop computers, desktop computers, CD players, DVD players, video game consoles, and the like. The cable assembly can facilitate hands free operation of cellular telephones. It can also facilitate listening to music players.

The cable assembly can comprise either one or two earpieces, each of which is configured to be received into the conchae of a user's ear. The earpiece(s) can be configured so as to be held in place by at least one anatomical structure of the conchae. A speaker can be in acoustic communication with each earpiece. A cable can be configured to communicate a signal representative of sound from the personal electronic device to each earpiece. A microphone can be permanently attached or removably attachable to the cable to facilitate use with a cellular telephone.

For example, a cable assembly for a cellular telephone or the like can comprise at least one earpiece configured to be received into a conchae of an ear and configured to be held in place by at least one anatomical structure of the conchae. At least one speaker can be in acoustic communication with each earpiece. A cable can be configured to communicate a signal representative of sound from a cellular telephone to each earpiece.

As a further example, a cable assembly for music players and the like can comprise two earpieces, wherein each earpiece is configured to be received into the conchae of an ear and held in place by at least one anatomical structure of the conchae. At least one speaker can be in acoustic communication with each earpiece, so as to facilitate stereo listening. A cable configured to communicate a signal representative of sound from a music player to each earpiece.

As a further example, a universal cable assembly for a personal electronic device can comprise at least one earpiece that is configured to be received into the conchae of an ear and held in place by at least one anatomical structure of the conchae. At least one speaker can be in acoustic communication with each earpiece. A cable can be configured to communicate a signal representative of sound from a cellular telephone to each earpiece. A microphone can be either permanently attached or removably attachable to the cable. Thus, the universal cable assembly is suitable for use with both cellular telephones and music players, as well as other personal electronic devices.

When using the cellular telephone cable assembly, the speaker can readily be heard, the picking up of extraneous noise by the microphone is substantially mitigated, third parties cannot readily hear both sides of a conversation, susceptibility to radio frequency interference is substantially eliminated, and security is enhanced. Further, the cellular telephone cable assembly is less bulky, cumbersome, and inconvenient to use than contemporary headsets and their associated cable assemblies.

This invention will be more fully understood in conjunction with the following detailed description taken together with the following drawings.

### BRIEF DESCRIPTION OF THE DRAWINGS

FIG. 1 is a semi-schematic front view of the upper portion of a cellular telephone/music player cable assembly, according to an example of an embodiment;

FIG. 2 is a semi-schematic enlarged cross-sectional view of the speaker of FIG. 1;

FIG. 3 is a semi-schematic enlarged view, partially in section, of the female connector of FIG. 1;

FIG. 4 is an electrical schematic of the sound limiter of FIG. 3;

FIGS. 5 and 6 are semi-schematic perspective views of the speaker upper housing of FIG. 1;

FIG. 7 is a semi-schematic cross-sectional view of the speaker upper housing of FIG. 1;

FIGS. 8 and 9 are semi-schematic perspective views of the speaker lower housing of FIG. 1;

FIG. 10 is a semi-schematic cross-sectional view of the speaker lower housing of FIG. 1;

FIG. 11 is a semi-schematic perspective view of the speaker boot;

FIG. 12 is a semi-schematic cross-sectional view of the speaker boot;

FIG. 13 is a semi-schematic front view of the lower portion of a cellular telephone/music player cable assembly (the microphone can be omitted for use with music players), according to an example of an embodiment;

FIG. 14 is a semi-schematic enlarged cross-sectional view of the microphone of FIG. 1;

FIG. 15 is a semi-schematic enlarged perspective view of the microphone buffer of FIG. 14;

FIGS. 16 and 17 are semi-schematic perspective views of the microphone upper housing of FIG. 1;

FIG. 18 is a semi-schematic cross-sectional view of the microphone upper housing of FIG. 1;

FIG. 19 is an electrical schematic of the cable assembly, according to an example of an embodiment;

FIG. 20 is a semi-schematic view of a stereo cable assembly according to an example of an embodiment;

FIG. 21 is a perspective view of an earpiece having a flanged extension for use with a cellular telephone/music player cable, according to an example of an embodiment;

FIG. 22 is a perspective view of the extension of the earpiece of FIG. 21 wherein the extension is removed from the earpiece;

FIG. 23 is a perspective view of one alternative embodiment of the extension of FIG. 22, wherein openings are formed in the flanges thereof;

FIG. 24 is a perspective view of another alternative embodiment of the extension of FIG. 22, wherein openings are formed in the stem thereof;

FIG. 25 is a perspective view of the extension of FIG. 22, showing a Hoch's filter inserted therein;

FIG. 26 is a side view of the earpiece of FIG. 21, wherein the extension is removed therefrom;

FIG. 27 is a bottom view of the earpiece of FIG. 26, showing the aperture therein with dashed lines;

FIG. 28 is a perspective view of an earpiece having a flanged extension according to an example of an embodiment;

FIG. 29 is a perspective view of the extension of the earpiece of FIG. 28 wherein the extension is removed from the earpiece;

FIG. 30 is a perspective view of the earpiece of FIG. 21 having acoustic tubing attached thereto;

FIG. 31 is a perspective view of the flanged extension of FIG. 21, showing the Hoch filter exploded therefrom and also showing a flexible skin (dashed lines) formed partially thereover;

FIG. 32 is a perspective view of a flanged extension having three flanges, according to an example of embodiment;

FIG. 33 is a perspective view of a flanged extension having four flanges, according to an example of an embodiment;

FIG. 34 is a perspective view of a foam, fiber, or fabric extension, according to an example of an embodiment;

FIG. 35 is a side view of a foam, fiber, or fabric extension having a sound transmissive bore formed therethrough according to an example of an embodiment, the bore being shown in dashed lines;

FIG. 36 is a side view of a tapered foam, fiber, or fabric extension, according to an example of an embodiment; and

FIG. 37 is a side view of an extension that is not inserted substantially into the ear canal, according to an example of an embodiment.

Embodiments of the present invention and their advantages are best understood by referring to the detailed description that follows. It should be appreciated that like reference numerals are used to identify like elements illustrated in one or more of the figures.

### DETAILED DESCRIPTION

A method and system for enhancing the utility of personal electronic devices such as cellular telephones and music players is disclosed. The method and system can include a way to communicate sound and/or a signal representative of sound from the personal electronic device to a user's ear and/or a way to communicate sound and/or a signal representative of sound from a user's mouth to the personal electronic device.

Although cellular telephones and music players (such as MP3® players and iPods®) are discussed herein, such discussion is by way of example only and not by way of limitation. Those skilled in the art will appreciate that one or more embodiments can be used with a variety of different personal electronic devices such as cellular telephones, radios (both one way and two way radios), MP3® players, iPods®, pocket computers, laptop computers, desktop computers, CD players, DVD players, video game consoles, and the like. Cellular telephones can be stand-alone cellular telephones, or can be integrated with other devices, such as music players, PDA's, and computers. Music players can include radios, MP3® players and iPods®, pocket computers, laptop computers, desktop computers, CD players, and DVD players.

Further, it should be appreciated that the distinction between different personal electronic devices tends to be blurring over time. For example, cellular telephone and music players are presently being combined into a single personal electronic device. One impact of this is the need for a common cable assembly that is suitable for use with a personal electronic device that provides more than one function, such as a personal electronic device that provides both telephone and music player functionality. One or more embodiments comprise such a cable assembly. Further, an embodiment described as for use with one type of personal electronic device, e.g., a cellular telephone, can be used with another type of personal electronic device, e.g., a music player.

One or more embodiments comprise a cable that can be configured to communicate sound and/or signals representative of sound from a personal electronic device to the user's ear or ears and/or can be used to communicate sound and/or signals representative of sound from a user's mouth to the personal electronic device. The cable can comprise one or more speakers and/or earpieces. For example, the cable can comprise one speaker and one earpiece, one speaker and two earpieces (where the single speaker is shared by the two earpieces), or two speakers and two earpieces (where each earpiece has a dedicated speaker—such as for stereo listening).

Generally, when the cable is configured for use with a cellular telephone, then only a single speaker and earpiece is provided, although any desired combination of speakers and earpieces can be provided. Generally, when the cable is configured for use with a cellular telephone, then a microphone is also provided. However, the microphone can be omitted, if desired. For example, the microphone can be omitted from the cable and the built-in microphone of the cellular telephone can be used instead.

Generally, when the cable is used with a music player, then two speakers and two earpieces (where each earpiece has a dedicated speaker for stereo listening) are used. Generally, the microphone can be omitted in a cable used with a music player. However, a general purpose cable that is suitable for use with either a cellular telephone or a music player (as well as with other personal electronic devices) can include a microphone.

The microphone can have a housing, a microphone transducer disposed within the housing, and a buffer disposed intermediate the microphone transducer and the housing so as to mitigate undesirable noise. The speaker can have a speaker transducer disposed within a housing that is comprised of a substantially rigid material that enhances durability. The cable assembly can facilitate electrical communication between the personal electronic device and the microphone, as well as between the personal electronic device and the speaker.

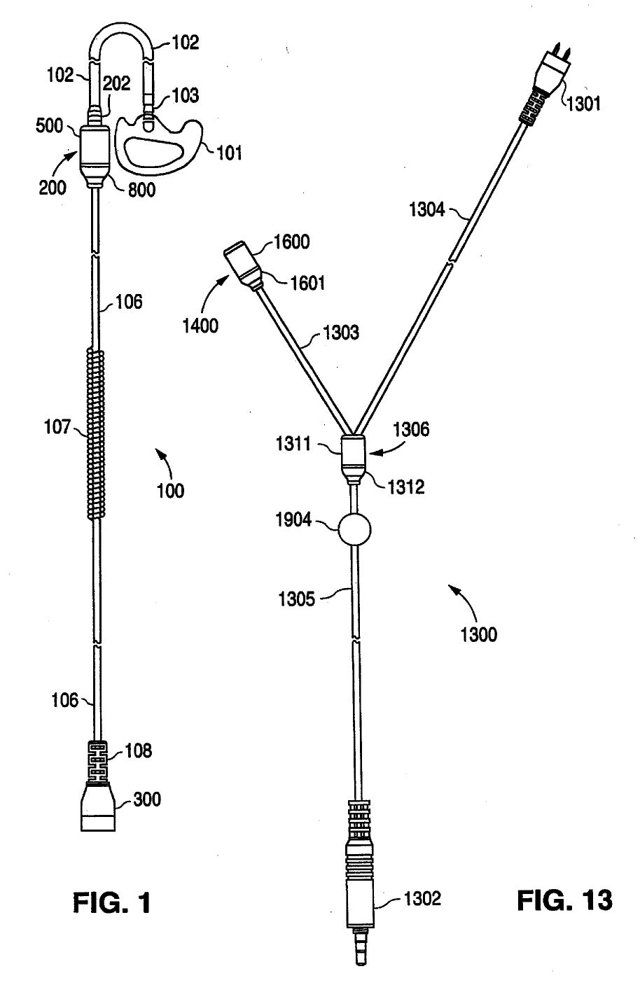

The cable assembly comprises an upper portion 100, as shown in FIG. 1 and a lower portion 1300, as shown in FIG. 13. Upper portion 100 can be connected to lower portion 1300 to form the complete cable assembly.

Referring now to FIG. 1, upper portion 100 can comprise an earpiece that is configured to fit within the conchae of a user's ear so as to transmit sound (such as incoming cellular telephone transmissions) to the user's eardrum. Examples of suitable earpieces are disclosed in U.S. patent application Ser. No. 11/411,314, filed on Apr. 26, 2006, and entitled Earpiece With Extension, the entire contents of which are hereby expressly incorporated by reference. The earpiece can be used either with or without the extension.

Earpiece 101 can be attached to acoustic tubing 102, such as via barbed fitting 103. Acoustic tubing 102 can be curved so as to facilitate easy routing thereof behind the ear. Speaker 200 can be worn directly behind the ear, behind the ear at the neck, in front of the ear, in the ear, or at any other desired location. Either acoustic tubing from speaker 200 or electrical cable to speaker 200 can pass by or behind the ear. Barbed fitting 103 can be an elbow fitting.

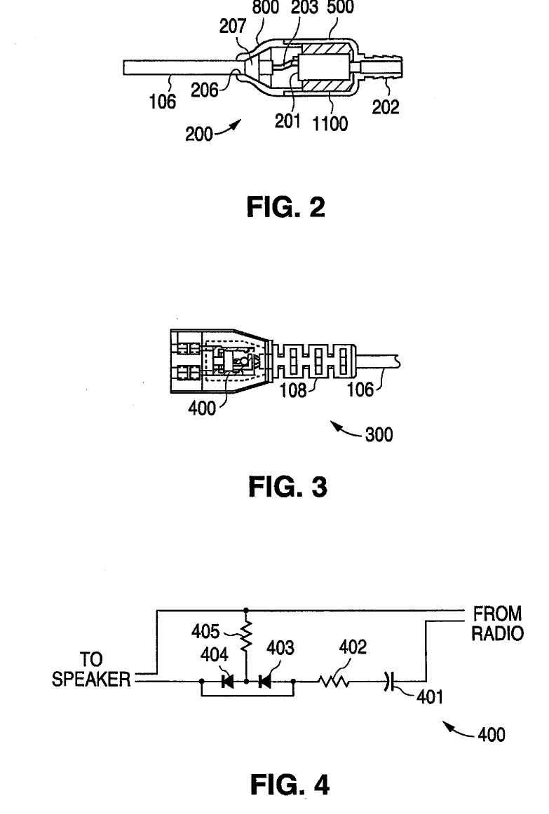

Acoustic tubing 102 can be attached to speaker 200, such as via a barbed fitting 202 (better shown in FIGS. 2 and 5-7) thereof. Speaker 200 can comprise upper 500 and lower 800 housings, as discussed in detail below. A multi-conductor electrical cable 106 can extend from speaker 200 to a connector, such as female connector 300 that electrically connects upper portion 100 of the cable assembly 2000 to lower portion 1300 (FIG. 13) thereof. For example, electrical cable 106 can comprise two conductors that facilitate operation of speaker 200. Strain relief 108 can be provided for electrical cable 106 at connector 300. Electrical cable 106 can comprise coils 107 that allow it to stretch as necessary to fit a particular individual.

Electrical cable 106 can provide electrical signals to speaker 800. Speaker 800 can convert such electrical signals into acoustic signals representative thereof (and generally representative of speech or music such as that received from a cellular telephone, music player, or the like).

Referring now to FIG. 2, a speaker housing can enclose and protect a speaker transducer 201. The speaker housing can comprise upper speaker housing portion 500 and lower speaker housing portion 800. Upper speaker housing portion 500 and lower speaker housing portion 800 can be formed of a durable, substantially rigid material.

For example, upper speaker housing portion 500 and lower speaker housing portion 800 can be formed of a metal or alloy, such as a metal or alloy comprised of aluminum (anodized aluminum, for example), titanium, magnesium, or steel. Alternatively, upper speaker housing portion 500 and lower speaker housing portion 800 can be formed of a polymer, such as ABS, polycarbonate, or high density polyethylene. Upper speaker housing portion 500 can attach to lower speaker housing portion 800 via threads, friction fit, adhesive bonding, ultrasonic welding, or by any other desired method.

Speaker transducer 201 can be selected so as to provide a substantially flat (when not modified by a sound limiting circuit) and clean response. A sound limiting circuit can be used to modify the response of speaker transducer 201 so as to enhance the comfort, utility, and safety thereof.

For example, the sound limiting circuit can modify the otherwise flat response so as to have dips in the response curve where objectionable noise is known to occur. That is, the sound limiting circuit can mitigate such objectionable noise.

Cable 106 enters lower speaker housing portion 800 through opening 206 formed therein. Ferrule 207 can be crimped around cable 106 to hold cable 106 within the speaker housing, to provide strain relief, and/or to seal the speaker housing (such as to seal moisture, atmospheric particulates and other contaminants out of the speaker housing). A knot (not shown) can be formed in cable 106 and or conductors 203 thereof to inhibit cable 106 from being inadvertently pulled from the speaker housing.

Conductors 203 from electrical cable 106 are electrically connected to speaker transducer 201, so as to communicate speech from cellular telephone or the like, as discussed above. Other conductors (not shown) may be used for other purposes.

Speaker transducer 201 can be generally surrounded by a boot 1100, so as to provide shock and vibration damping to speaker transducer 201. Boot 1100 can be formed of a resilient polymer material, such as rubber, and is discussed in further detail below.

Referring now to FIG. 3, connector 300 can be used to attach upper cable assembly 100 to lower cable assembly 1300 (via connector 1301 of lower cable assembly 1300), as discussed above. Alternatively, upper cable assembly 100 can be permanently connected to lower cable assembly 1300.

Further, a sound limiting circuit 400 can be disposed within connector 300 so as to limit the amplitude and/or frequencies of sound communicated to the user's eardrum, as discussed in detail below. Sound limiting circuit 400 may comprise passive components, active components, or any combination thereof. Sound limiting circuit 400 may comprise discrete components formed upon a printed circuit board or may use any other desired method of packaging. Sound limiting circuit 400 may be analog, digital, or a combination of analog and digital.

Referring now to FIG. 4, sound limiting circuit 400 can be configured so as to prevent loud, annoying, distracting, and/or harmful sounds from being communicated from cellular telephone or the like to the user's eardrum. The amplitude and/or frequency of the sound can be controlled so as to enhance the safety, comfort, and/or utility of a cellular telephone or the like.

For example, sound limiting circuit 400 can comprise a capacitor 401 and a resistor 402 configured as an RC network so as to provide a desired frequency response. Capacitor 401 can be a 2.2 microfarad capacitor and resistor 402 can be a 100 ohm resistor, for example.

Further, sound limiting circuit 400 can comprise a pair of diodes 403, 404 and a resistor 405 configured so as to form an amplitude limiter that shunts excessive amplitudes so that they are not transformed into acoustic energy by speaker transducer 201. Diode 403 can be SOT-23 diode, diode 404 can be a BAV199 diode, and resistor 405 can be a 10 ohm resistor, for example. Those skilled in the art will appreciate that various such sound limiting circuits can be suitable for use in various situations.

For example, in situations where it is anticipated that undesirable sounds of a particular frequency may be present in the received cellular telephone signal or music player output, then sound limiting circuit 400 can be specifically configured to mitigate such sounds.

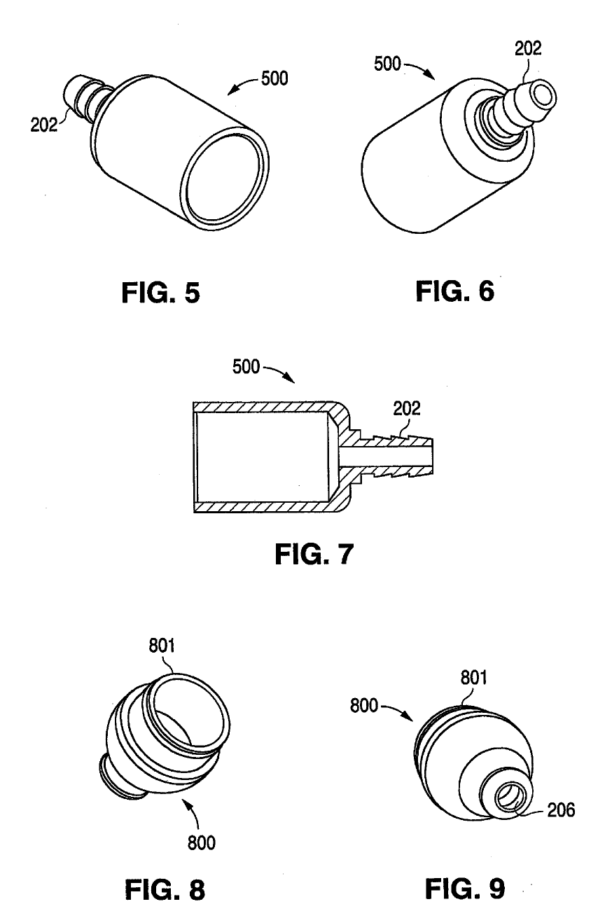

Referring now to FIGS. 5-7, the speaker housing can comprise upper housing 500 as mentioned above. Upper housing 500 can be generally cylindrical and substantially hollow. Thus, it can be configured to receive a miniature speaker, such as those commonly used with earpieces like earpiece 101. Barbed fitting 202 can extend from upper housing 500 and facilitates connection of upper housing 500 to acoustic tubing 102. Upper housing can have a diameter of approximately 8.0 mm, for example.

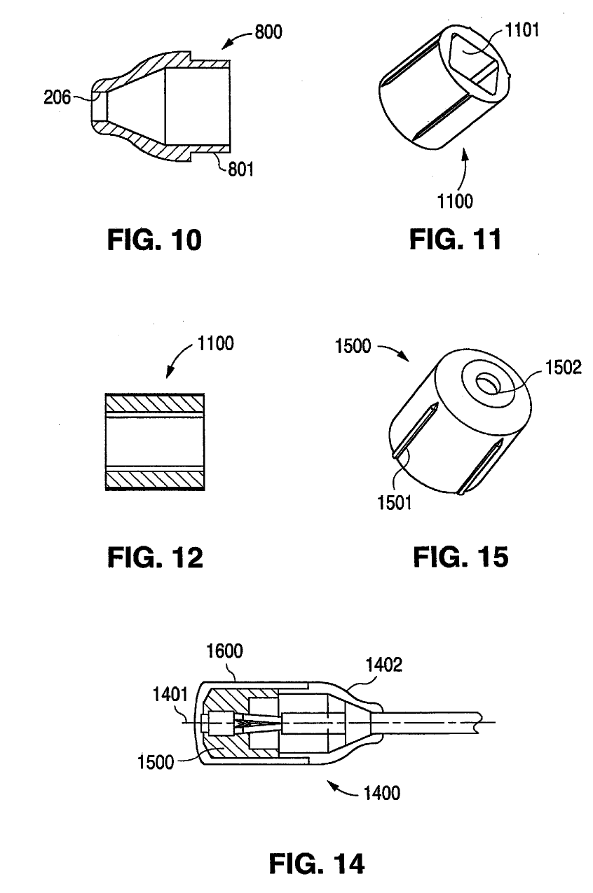

Referring now to FIGS. 8-10, the speaker housing can also comprise lower housing 800. Lower speaker housing 800 can comprise an area of reduced diameter 801 that is configured to be received within upper housing 500 (as shown in FIG. 2) so as to facilitate attachment of lower housing 800 to upper housing 500.

Referring now to FIGS. 11-12, boot 1100 can be generally cylindrical in shape and can have a diameter approximately equal to the inside diameter of upper housing 500. Boot 1100 can be formed of a resilient polymer material. Boot 1100 can have a diameter slightly greater than the inside diameter of upper housing 500, such that boot 1100 must be compressed slightly in order to insert it into upper housing 500. Boot 1101 can have a generally square opening formed therein for receiving speaker transducer 201.

Referring now to FIG. 13, lower cable assembly 1300 can comprises a microphone 1400 that is configured to attach to the user's clothing, such as proximate the user's mouth. For example, microphone 1400 can clip to the user's lapel. A connector, such as male connector 1301, can facilitate electrical connection of lower cable assembly 1300 to upper cable assembly 100 to define completer cable assembly 2000, as mentioned above.

A connector, such as stereo phono plug 1302, can be used to connect lower cable assembly 1300 (and consequently complete cable assembly 2000) to a personal electronic device. Phono plug 1302 can plug directly into the personal electronic device.

Cable 1303 facilitates electrical connection between microphone 1400 and connector 1302. Similarly, cable 1304 facilitates electrical connection between upper portion of cable assembly 100 and connector 1302. Cable 1303 and cable 1304 can join at Y-joint 1306 to form single cable 1305. Y-joint 1306 can comprise a housing similar in construction to the speaker housing. Cable 1303 can be omitted for use with a music player, such as an MP3® player or iPod®.

More particularly, an upper Y-joint housing portion 1311 and a lower Y-joint housing portion 1312 can be formed of a durable, substantially rigid material. For example, upper Y-joint housing portion 1311 and lower Y-joint housing portion 1312 can be formed of a metal or alloy, such as a metal or alloy comprised of aluminum (anodized aluminum, for example), titanium, magnesium, or steel. Alternatively, upper Y-joint housing portion 1311 and lower portion 1312 can be formed of a polymer, such as ABS, polycarbonate, or high density polyethylene. Upper portion 1311 can attach to lower portion 1312 via threads, friction fit, adhesive bonding, ultrasonic welding, or by any other desired method.

Microphone 1400 can be removably attachable to lower cable assembly 1300, such as via a connector. Alternatively, microphone 1400 can be permanently attached to 1300 lower cable assembly, such as by being an integral part thereof.

Referring now to FIG. 14, microphone 1400 can comprise a microphone transducer 1401 generally surrounded by a buffer 1500 and disposed within a housing comprised of upper housing 1600 and lower housing 1602. Upper housing 1600 is discussed in detail below. Lower housing 1402 can be similar to lower speaker housing 800.

Buffer 1500 can comprise a vibration damping material that mitigates the undesirable transmission of ambient sound and vibration to microphone transducer 1401 and, thus, enhances the quality of sound transmitted by a cellular telephone or the like. Buffer 1500 can comprise a resilient polymer material.

For example, if a person is riding in a noisy vehicle, then engine, wind, and other noise can be substantial. In the absence of buffer 1500, such engine noise can be undesirably transferred through the microphone housing and to microphone transducer 1401. When the person attempts to transmit a telephone message, the noise will be transmitted as well. However, buffer 1500 inhibits the transmission of such noise from the microphone housing to microphone transducer 1401 and thereby enhances transmission quality.

Further, the microphone housing can mitigate the undesirable generation and transmission of harmonics, thereby tending to acoustically stabilize the microphone. As those skilled in the art will appreciate, such harmonics detract from the ability of a listener to understand transmitted telephone messages.

Referring now to FIG. 15, buffer 1500 can be generally cylindrical in shape and can conform in size and shape to at least a portion of the inside of the microphone housing, such as the upper housing 1600 thereof. Buffer 1500 can comprise ribs 1501. Ribs 1501 can function as standoffs that reduce the cross-sectional area of the path for sound to travel from the microphone housing though buffer 1500.

That is, ribs 1501 can separate the bulk of buffer 1500 from the microphone housing. Ribs 1501 can also provide a tighter fit of buffer 1500 within the microphone housing, so as to prevent it from slipping therefrom, such as during assembly thereof. An opening 1502 can be formed in upper buffer 1500, so as to facilitate the transmission of airborne sound to microphone transducer 1401.

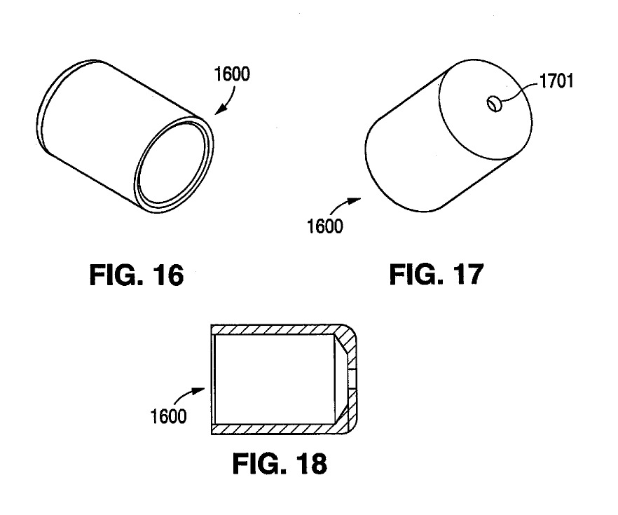

Referring now to FIGS. 16-18, microphone upper housing 1600 is generally cylindrical in shape. An opening 1701 can be formed in upper housing 1600, so as to facilitate the transmission of airborne sound to microphone transducer 1401.

Upper microphone housing portion 1600 and lower microphone housing portion 1601 can be formed of a durable, substantially rigid material. For example, upper microphone housing portion 1600 and lower microphone housing portion 1601 can be formed of a metal or alloy, such as a metal or alloy comprised of aluminum (anodized aluminum, for example), titanium, magnesium, or steel. Alternatively, upper microphone housing portion 1600 and lower microphone housing portion 1601 can be formed of a polymer, such as ABS, polycarbonate, or high density polyethylene. Upper microphone housing portion 1600 can attach to lower portion 1601 via threads, friction fit, adhesive bonding, ultrasonic welding, or by any other desired method.

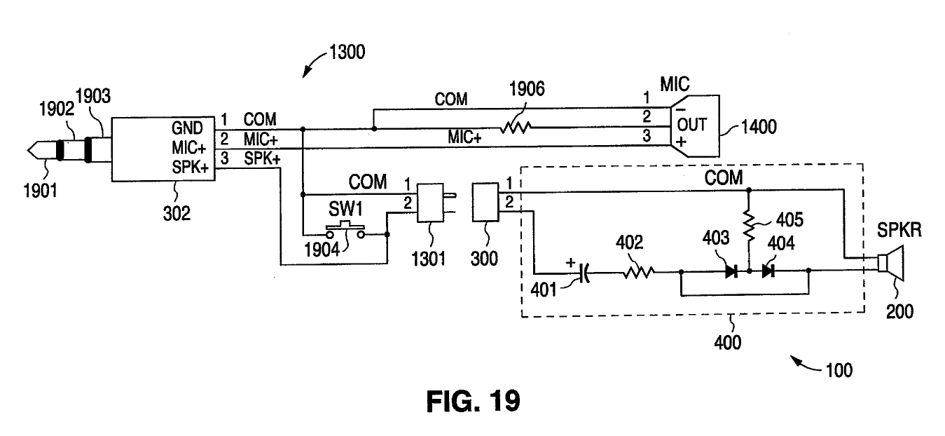

Referring now to FIG. 19, an electrical schematic of an example of an embodiment of the cable assembly is provided. A connector, such as stereo phono plug 302, facilitates electrical connection of the cable assembly to a personal electronic device.

The use of stereo phono plug 302 provides for three separate electrical connections to a personal electronic device. The tip 1901 of phone plug 302 can be used to provide electrical connection for speaker 200. The middle 1902 of phono plug 302 can be used to provide electrical connection for microphone 1400. The base 1903 of phono plug 302 can be a common conductor, e.g., ground, for both speaker 200 and microphone 1400. Other configurations of phono plug 302 and other types of connectors can alternatively be utilized.

Optionally, a push-to-talk switch 1904 can be used to facilitate transmission of voice according to well known principles. For example, push-to-talk switch 1904 can be used when the cable assembly is to be used with a two-way radio, e.g., a walkie talkie. However, push-to-talk switch 1904 can be omitted when the cable assembly is used with many personal electronic devices.

A resistor 1906 can be used for current limiting or impedance matching for microphone 1400. As those skilled in the art will appreciate, various other components can be used in the cable assembly for a variety of different purposes.

As discussed above, male connector 1301 and female connector 300 can be used to connect lower cable portion 1300 to upper cable portion 100. Alternatively, lower cable portion 1300 and upper cable portion 100 can be formed integrally, as a one-piece cable assembly that eliminates the need for connectors 300 and 1301.

As discussed above, sound limiting circuit 400 enhances the comfort and safety of the user by modifying the electrical signal prior to the electrical signal being converted into acoustic energy. Sound limiting circuit 400 can be inside of connector 300.

Alternatively, sound limiting circuit 400 can be inside of connector 1301, inside of phono plug 302, inside of the speaker 200 or at any other desired location on cable assembly 2000. For example, sound limiting circuit 400 can be along cable 106.

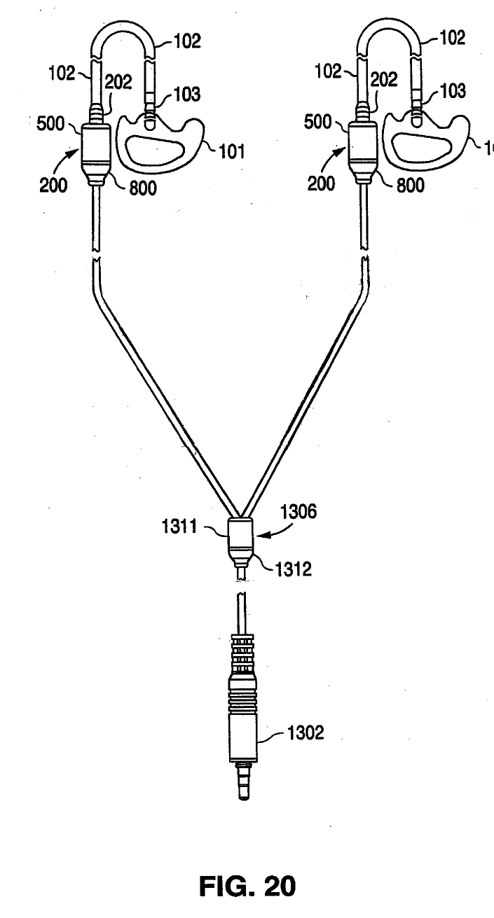

Referring now to FIG. 20, Y-joint 1306 can be used to form a two speaker/two earpiece cable, such as for stereo listening to a music player. Optionally, the microphone 1400 can be included, such as by additionally having microphone cable 1303 branch off from Y-joint 1306 as well.

Instead of having two separate speakers for a stereo configuration as shown in FIG. 20, the cable assembly can alternatively have a single speaker that provides sound to both earpieces to define a monaural configuration. For example, a single speaker can be placed at Y-joint 1306 and two acoustic tubes can lead therefrom to earpieces 101.

According to an example of an embodiment, an earpiece is held in place by anatomical structures of the ear and the earpiece holds the extension in place within the ear canal. That is, the earpiece prevents the extension from loosening or falling out of the ear canal.

According to another example of an embodiment, the earpiece positions a sound port at the distal end of the extension near the eardrum, so that the volume of a personal electronic device can be reduced. That is, the earpieces can determine how far into the ear canal the extension extends.

Various combinations of sound attenuation and sound transmission may be provided. For example, a hollow or partially hollow extension may be configured so as to substantially attenuate some ambient sound (such as potentially harmful loud noise), while allowing some ambient sound (such as voices) to be heard. Optionally, the extension can comprise one or more openings that allow a substantial portion of ambient sound to be heard, while also allowing communications, such as cellular telephone communications, to be heard. Optionally, a filter may be used to selectively allow sounds to be heard.

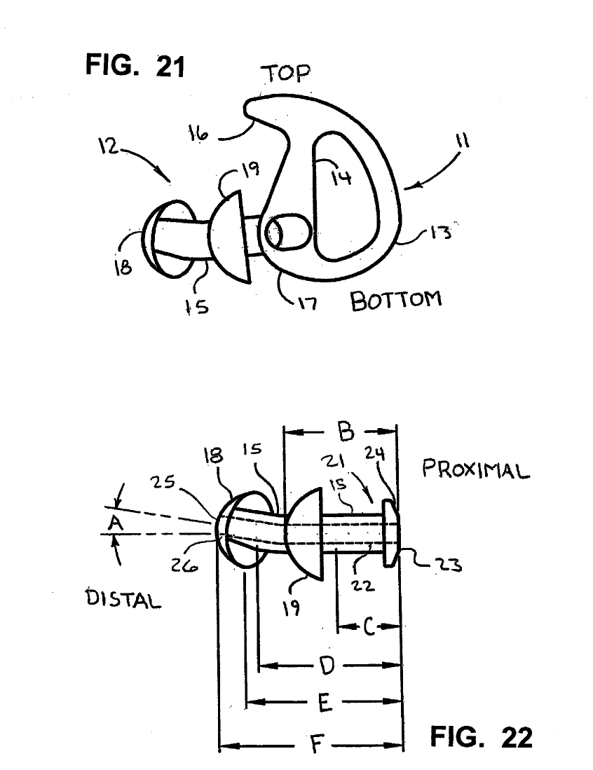

Referring now to FIGS. 21, 22, 26, and 27, one embodiment comprises an earpiece 11 to which an extension 12 is attached. Earpiece 11 is configured to be disposed in the conchae of the outer ear. Extension 12 is configured to be disposed within the ear canal.

Earpiece 11 can have a generally D-shaped configuration. Earpiece 11 can comprise a generally arcuate rib 13 that has upper and lower ends. Arcuate rib 13 can be attached to a straight rib 14 at the upper and lower ends of arcuate rib 13. An upper lobe 16 can be formed proximate where arcuate rib 13 and straight rib 14 join at the top of earpiece 11. Similarly, a lower lobe 17 can be formed proximate where arcuate rib 13 and straight rib 14 join at the bottom of earpiece 11.

Earpiece 11 is configured to be disposed and held in place within the conchae of a human ear. More particularly, the crus and the antihelix of a wearer's ear cooperate to capture upper lobe 16 and the tragus and antitragus cooperate to capture lower lobe 17. The antihelix and the antitragus cooperate to capture arcuate rib 13.

Thus, earpiece 11 is configured to be captured by protrusions of the conchae. In this manner, earpiece 11 is held firmly in place within the conchae and can therefore maintain extension 12 in a desired position within the ear canal.

Extension 12 can be either removably or permanently attached to earpiece 11. Extension 12 can be removably attached to earpiece 11 by friction fit, by detents, by threads, or by any other desired means.

For example, extension 12 can be friction fit to earpiece 11 by sizing a proximal portion 21 (FIG. 2) of extension 12 so as fit tightly within an aperture 61 (FIG. 6) of earpiece 11.

Extension 12 can be permanently attached to earpiece 11 by adhesive bonding, ultrasonic welding, or by any other desired means. Alternatively, extension 12 can be integrally formed to earpiece 11, such as by injection molding earpiece 11 and extension 12 within a common mold cavity. Thus, earpiece 11 and extension 12 can be formed either integrally or separately.

Earpiece 11 and extension 12 can be formed of a soft, resilient material to enhance comfort during use. Both earpiece 11 and extension 12 can be formed of the same material.

For example, earpiece 11 and extension 12 can be formed of a resilient polymer, such as silicon rubber. Earpiece 11 and extension 12 can be formed of a material having a Shore A durometer of between 35 and 45, such as a Shore A durometer of approximately 40.

Earpiece 11 functions as a stop to prevent extension 12 from being inserted too far into the ear. Earpiece 11 also prevents extension 12 from being inadvertently removed or loosened from the ear. The length of extension 12 determines, at least in part, how close the tip thereof is positioned with respect to the eardrum.

With particular reference to FIG. 22, according to one embodiment extension 12 comprises a stem 15 and two flanges, 18 and 19. Extension 12 can comprise any desired number of flanges, including no flanges at all, as discussed in further detail below. Stem 15 can either be solid (so as to substantially block sound) or hollow (so as to substantially transmit sound). Stem 15 can also be partially hollow (so as to selectively transmit sound).

Stem 15 can bend such that it angles upwardly to conform to the upward angle of the human ear canal. For example, stem 15 can bend such that it angles upwardly at an angle, Angle A, of approximately 30°. The distance between the proximal end of extension 12 and the distal end of outer flange 19, Dimension B, can be approximately 0.545 inch. The distance between the proximal end of extension 12 and the point where a filter (such as a Hoch filter) ends, Dimension C, can be approximately 0.304 inch. The distance between the proximal end of extension 12 and the bend in stem 15, Dimension D, can be approximately 0.680 inch. The distance between the proximal end of extension 12 and a distal end of inner flange 18, Dimension E, can be approximately 0.743 inch. The distance between the proximal end of extension 12 and the distal end of inner flange 18, Dimension F, can be approximately 0.870 inch.

The diameter of stem 15 can be approximately 0.189 inch. Stem 15 can optionally have a bore 22 formed therethrough. Bore 22 can have a diameter of approximately 0.094 inch. Outer flange 19 can have a radius of approximately 0.241 inch.

Similarly, inner flange 18 can have a radius of approximately 0.193 inch. Thus, the radius of inner flange 18 can be substantially less than the radius of outer flange 19, so as to better accommodate the manner in which the human ear canal becomes narrower as it gets deeper.

The exemplary angle and dimensions discussed above provide a single extension that is suitable for use by a large number individuals. Those skilled in the art will appreciate that other dimensions are likewise suitable.

The distal end of bore 22 defines a sound output port 26 (FIGS. 2 and 9). Extension 12 is configured such that sound output port 26 is positioned proximate the wearer's eardrum. That is, extension 12 can be configured so as to position a distal end 25 thereof proximate the eardrum.

In this manner, sound transmitted through bore 22 (such as sound from a cellular telephone), is brought close to the eardrum such that the volume of the sound required can be substantially reduced. For example, the extension can position sound output port 26 within one, two, or three millimeters of the eardrum. The extension can have a length of approximately ½ inch. The extension can have a length of ⅝ inch or more.

A head 23 can be formed upon the proximal end of stem 15 so as to enhance friction with respect to aperture 61 of earpiece 11 and/or so as to define detents that tend to keep extension 12 attached to earpiece 11. Bevels 24 can optionally be formed upon head 23 to better facilitate insertion of head 23 through aperture 61.

The extension may comprise a flanged extension, having flanges as shown in FIGS. 22-25 and 28-31. The flanges generally fill (close off) the ear canal and tend to block ambient sound. Although sometimes it is desirable to block ambient sound, other times, it is desirable for the user to hear ambient sound.

Thus, the flanges can have opening formed therein, as discussed below. Although two flanges are shown, the extension may comprise more or less flanges. For example, the extension may comprise three, four, five, six, or more flanges. The flanges need not be identical, but rather may vary in size, shape, orientation and/or positions of attachment to the stem, for example.

The extension can have a bore formed therethrough to facilitate the transmission of sound from a speaker (such as via acoustic tubing connected to the speaker) to the user's eardrum. Alternatively, the extension can lack such a bore, so as to define an earplug, such as for attenuating ambient sound.

Indeed, the bore and/or openings in the stem and/or flanges can be configured so as to selectively transmit and block desired sounds. Such selectivity can be based upon the frequency and/or intensity of the sound.

A user can wear one earpiece having an extension with a bore and one earpiece lacking a bore. The earpiece having an extension with a bore facilitates listening to a personal electronic device, while the earpiece having an extension without a bore at least partially blocks distracting and/or potentially harmful ambient sound.

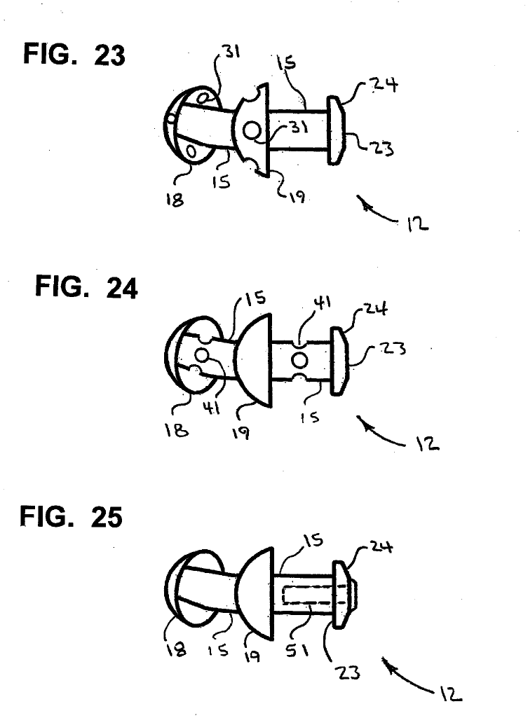

Referring now to FIG. 23, flanges, 18 and 19, of extension 12 can optionally have one or more openings 31 form therein. For example, each flange, 18 and 19, can have one, two, three, or four openings 31 formed therein. Openings 31 can be holes.

Alternatively, the openings 31 can be cutouts, such as notches formed in the flanges. The openings allow at least some ambient sound to better reach the user's eardrum.

Such openings 31 may be desirable when listening to a personal electronic device and when it is also desirable to hear ambient sound. For example, such openings 31 may be desirable when it is necessary to hear both a personal electronic device and face-to-face conversations.

Referring now to FIG. 24, one or more openings 41 can be formed in stem 15, such as intermediate or proximate flanges, 18 and 19. A curable polymer material suitable for use in the ear canal can be injected into the tube such that it substantially fills the tube and/or at least some space between the flanges. That is, the injected polymer material extrudes from the openings and tends to fill in the space intermediate the flanges.

Such injection may be accomplished with the extension inserted into a wearer's ear canal, so as to provide a custom fit. Alternatively, this injection may be performed using an artificial ear canal, such as for mass production.

Silicon rubber may be used as the extrudable material. Generally, any extrudable material suitable for use as earplugs can be used. In this fashion, attenuation of ambient sound is enhanced. Such earplugs are suitable for use in gun ranges and noisy industrial environments.

The opening at the distal end of the tube can optionally be closed to prevent leakage of the injected polymer material therefrom. A skin may be formed over the flanged extension to trap the polymer material and/or to facilitate easier insertion into the ears. Alternatively, the openings can be omitted and the central bore of the tube can still be filled with polymer material to attenuate sound.

Referring now to FIG. 25, a filter 51 can be inserted into bore 22 to selectively mitigate sound exposure. For example, a Hoch filter can be used to mitigate exposure to louder sounds, while still allowing a wearer to hear quieter sounds, such as speech.

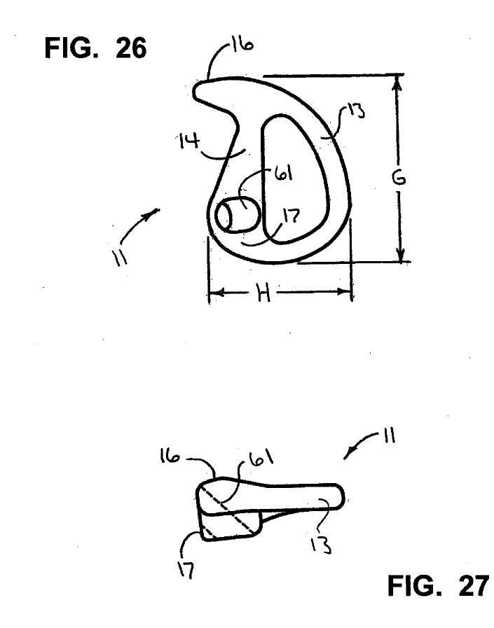

Referring now to FIGS. 26 and 27, an earpiece 11 that is configured for use in the left ear is shown with the extension removed therefrom. Arcuate rib 13 and straight rib 14 define a D shape. When a mirror image arcuate rib and straight rib are configured for use in the right ear, a reverse (mirror image) D is similarly defined.

For a medium size earpiece, the height, Dimension G, can be approximately 1.087 inch and the width, Dimension H, can be approximately 0.802 inch. For a large size earpiece, the height, Dimension G, can be approximately 1.150 inch and the width, Dimension H, is approximately 0.850 inch. The medium size fits a large percentage of people.

The medium size earpiece can be configured to fit most adult ears. More particularly, the medium size earpiece can be configured to fit at least 70% of ears of men between 19 and 40 years old. Arcuate rib 13 tends to deform or bend so as to accommodate a wide range of ear sizes.

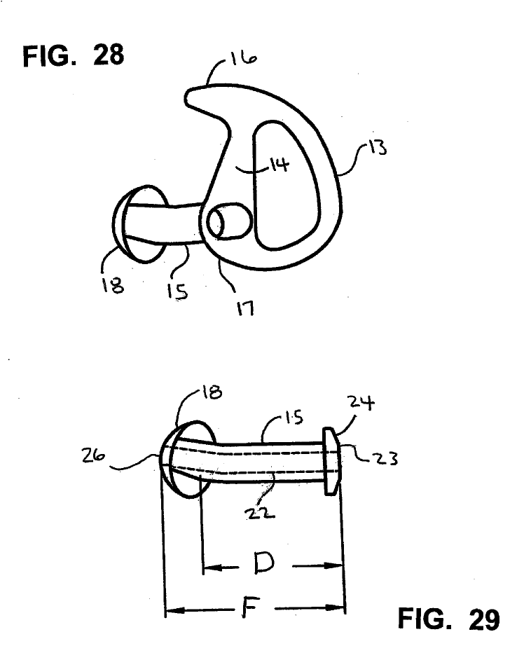

Referring now to FIGS. 28 and 29, outer flange 19 can optionally be omitted. Indeed, as mentioned above, extension 15 can comprise any desired number of flanges, including no flanges. In some instances, a single flange may perform adequately. This is particularly true when it is desirable to allow the wearer to hear ambient sound.

Omitting the other flange(s) better allows ambient sound to be heard. In some applications, the primary reason for wearing the earpiece may be to allow the wearer to better hear cellular telephone communications. Positioning output port 26 close to the eardrum accomplishes this goal.

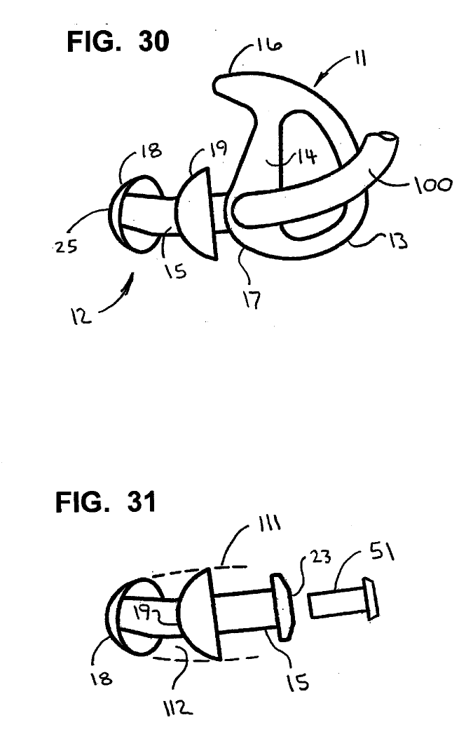

Referring now to FIG. 30, an acoustic tube 100 can be attached to earpiece 11 and/or extension 12 such that a generally continuous bore is defined for sound to travel though from a speaker to the eardrum. A barbed metal or plastic fitting can be used to accomplish such attachment. Other methods of attachment, such as the use of adhesive bonding and/or ultrasonic welding, are likewise suitable.

Since the distal end 25 of extension 12 can be placed close to a wearer's eardrum, the volume of a personal electronic device can be substantially reduced. With the volume reduced, sound advantageously cannot be as easily heard by others. Thus, the likelihood of someone other than the wearer hearing sound from a personal electronic device is substantially mitigated. Generally, it is annoying to others for them to hear such sound. Therefore, it is beneficial to mitigate such annoyance. Further, many times conversations are private and a user does not want others to hear the conversation.

By reducing the sound volume, smaller, less powerful, and/or less expensive speakers can be used. Placing the sound closer to the eardrum can make it easier for the hearing impaired to hear.

Sound transmissive embodiments (such as those embodiments having a bore 22 formed through stem 15) can similarly be used with a variety of personal electronic devices that produce sound, including two-way radios, cellular telephones, MP3® players, CD players, cassette players, personal digital assistants (PDAs), desktop computers, laptop computers, notebook computers, pocket PCs, and hearing aids.

Referring now to FIG. 31, according to another embodiment, extension 15 comprises one or more flanged members, 18 and 19 (similar to those of FIGS. 25, 26, and/or 27), having a skin or covering 111 formed thereover. Covering 111 can be formed of a thin resilient material, such as rubber, such as that of which common balloons are formed. Optionally, foam or gel 112 can be disposed between the covering 111 and flanged members 18 and 19. Foam or gel 112 can comprise a biocompatible material, such as a silicon material. Foam or gel 112 can extend proximal of outer flange 19, if desired.

Foam or gel can be injected between covering 111 and flanged members, 18 and 19, through openings 41 (FIG. 4), as discussed above. Thus, such a covering 111 can be used with extension 12 shown in FIG. 4, where an extrudable substance (which can be a foam or gel) is injected into bore 22 and passes through holes 21 to fill the void between the flanges, 18 and 19.

Thus, according to at least one embodiment the extension can comprise a tube (such as stem 15) and a rubber skin or covering, wherein foam, gel, or some other resilient substance is disposed between the tube and the rubber skin. An embodiment can optionally comprise one or more flanges. The tube can be formed of a flexible polymer material. However, the tube may alternatively be formed of a rigid polymer or metal material. The tube, foam, and skin can be attached to one another via any desired combination of friction fitting, adhesive bonding, and ultrasonic welding. The extension can be tapered to facilitate easy insertion into the ear canal and to provide a good fit therein.

One advantage of having more flanges is that the device is better secured in the ear. Another advantage of having more flanges, particularly if the flanges do not have holes formed therein, is that ambient sound is better mitigated before reaching a wearer's eardrum. Another advantage of having more flanges, particularly if the flanges do not have holes formed therein, is that the sound of the personal electronic device is better prevented from escaping the ear, such that it may be undesirably heard by others.

Any of the flanged extensions disclosed herein can either be ambidextrous (formed to fit either the right or left ear), or can be dedicated to fit only one ear. Thus, the flanges can be either radially symmetric or can be asymmetric such that they tend to be optimized for a particular ear (left or right). They can also be optimized in configuration so as to better fit a particular person's ear.

According to one aspect, earpiece 11 is configured to fit multiple sizes of ears. More particularly, arcuate rib 13 is deformable so as to permit earpiece 11 to fit into smaller conchae bowls.

The hole 61 (FIG. 6) in earpiece 11 can be configured such that the flanged extension is positioned at the top of the ear canal, at the bottom of the ear canal, at one side of the ear canal, or is approximately centered in the ear canal. Configuring the hole such that the flanged extension is not approximately centered causes the flanged extension to be biased toward an inner surface of the ear canal and can help to keep the earpiece and extension in the ear.

However, as long as the earpiece and/or the flanges of the extension are sufficient to keep the earpiece and extension in the ear, then the flanged extension can be position approximately in the center of the ear canal. Positioning the flanged extension approximately in the center of the ear canal may be more comfortable for some wearers.

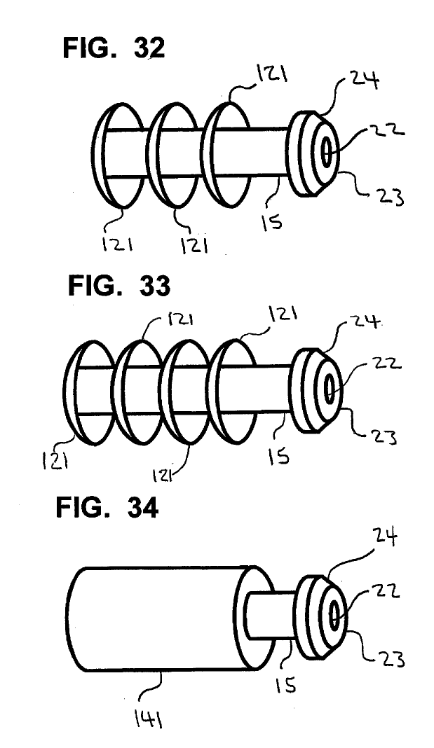

Referring now to FIG. 32, the extension can have three flanges 121 formed upon stem 15 thereof. As those skilled in the art will appreciate, the use of more flanges generally provides better sound reduction. The use of more flanges can also better secure the extension within the ear canal.

Referring now to FIG. 33, the extension can have four flanges 121 formed upon stem 15 thereof. Indeed, the extension can have any desired number of flanges formed upon stem 15 thereof.

The flanges of any embodiment of can be formed integrally with the stem. Alternatively, the flanges can be formed separately from the stem and can be formed of a different material with respect thereto.

Referring now to FIG. 34, stem 35 can be covered with a resilient substance such as foam, fiber, or fabric. Foam, such as a polymer foam, can be used to define a portion of the extension. The foam is compressed before or as it enters the ear canal. It then expands so as to effectively block at least a portion of the ear canal.

In a similar manner, fiber such as cotton, can be used to define a portion of the extension. For example, cotton can cover a portion of the extension in a manner similar to the way that cotton covers the end of Q-Tips®. Cotton fiber is sufficiently compressible and resilient so as to function in a manner similar to foam.

Fabric, such as woven cotton, can similarly be used to cover a portion of the extension. Any desired combination of foam, fiber, and fabric may be used. For example, cotton fabric can be used to cover cotton fiber.

Referring now to FIG. 36, the foam, fiber, or fabric can be tapered. Tapering the resilient substance makes it conform better to the shape of the ear canal. Tapering the resilient substance can make insertion thereof into the ear canal easier.

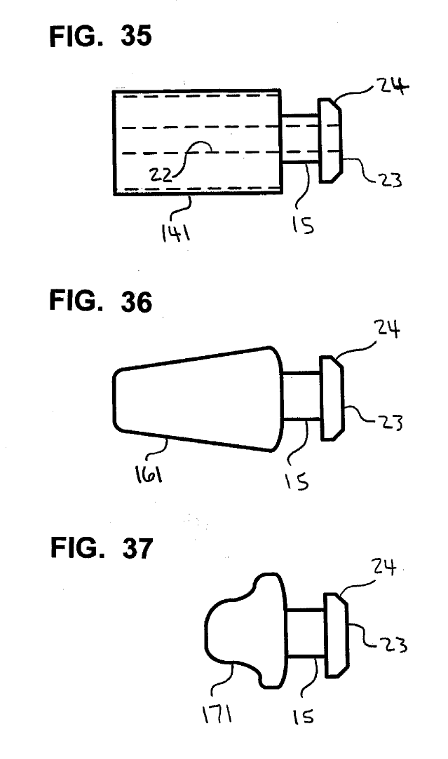

The resilient substance of FIGS. 34-36 can be formed over stem 15, as discussed above. Alternatively, the resilient substance can be attached to head 23 or the like without being formed over a stem. For example, the resilient substance can be attached to a shorter stem that does not pass substantially therethrough. As a further example, the resilient material can be attached directly to head 23 or the like.

Any desired combination of flanges, foam, fiber, and fabric can be used to at least partially block the ear canal and thereby mitigate the transmission of sound therethrough. For example, the middle flange of the extension of FIG. 32 could be replaced with a section of foam similar to the foam shown in FIG. 34.

The extension of any embodiment can be bent as shown in FIGS. 21-25 and 29-31 so as to better conform to the shape of the human ear canal. Alternatively, the extension can be straight as shown in FIGS. 32-35. If the extension is straight, it can be formed of a material that is bendable, so that the extension can conform, at least somewhat, to the shape of the human ear canal when inserted therein.

Referring now to FIG. 37, that portion 171 of the extension that is inserted into the ear canal can be formed such that it does not substantially enter the ear canal. The portion 171 can be formed of a rigid material or of a resilient substance. It can also be formed by providing a resilient layer over a substantially rigid material. It need only enter the ear canal far enough so as to be effective in mitigating the level of ambient sound reaching the eardrum.

The number of flanges and/or the selection of resilient material can selectively determine the intensity and/or frequencies of ambient sound that is transmitted thereto to a wearer's eardrum. Thus, control over the ambient sound that is heard can be achieved. Desirable, lower intensity sounds can be readily transmitted to the eardrum, while harmful, higher intensity sounds are attenuated.

The use of an extension moves sound closer to the eardrum, thus making it substantially easier to hear cellular telephones, music players, and the like. This can allow the cellular telephone or other device to operate at a substantially lower sound level, such as at 70-75 dB, for example. The extension can, for example, extend approximately half way up the ear canal. It has been found that the use of such an extension can boost sound by up to approximately 15 dB. Such a boost can make sound much easier to hear in noisy environments, such as in crowds. At the same time, the use of an open earpiece (an earpiece that does not completely obscure the ear canal, such as that shown in FIG. 21) allows the user to hear ambient sound. Such a boost of the sound level provides enhanced listening to cellular telephones and other devices that is beneficial for both hearing impaired and normal hearing people.

Although described herein as being for use in human ears, one or more embodiments can also be used in non-human ears. For example, an embodiment can be configured for canine ears, so as to mitigate noise exposure and/or facilitate communication with police or military dogs. As those skilled in the art will appreciate, such dogs are commonly exposed to noisy environments, such as those environments sometimes encountered in police work and on the battlefield. Further, it is frequently desirable to communicate with such dogs. Their ability to respond to radio commands has been established.

Thus, one or more embodiments can mitigate noise exposure and/or facilitate communications. Noise exposure is mitigated by at least partially blocking the ear canal with an extension from an earpiece. Communications are facilitated by providing a passage for sound through the extension. The extension extends to a point proximate the eardrum, so that sound is delivered more directly to the eardrum. Thus, less volume is needed. The use of less volume is useful in covert operations. As stated above, it may also facilitate the use of smaller, less powerful, and/or less expensive speakers.

In view of the foregoing, one or more embodiments can provide sound protection and/or communications facilitation in a manner that is comfortable, unobtrusive (and thus suitable for covert use), and effective. The earpiece is less likely to loosen or fall out as compared to contemporary earplugs. Positioning a sound output port close to the eardrum facilitates the use of lower personal electronic device volumes, while at the same time better assuring that communications are heard.

When using the cellular telephone cable assembly, the speaker can readily be heard because the earpiece delivers sound directly to the user's ear. Less extraneous noise is picked up by the microphone as compared to that which occurs when a cellular telephone is used as a speaker phone, because the microphone is positioned nearer to the user's mouth. Third parties cannot readily hear both sides of a conversation because the incoming portion of the conversation can be very low in volume since it is delivered directly to the user's ear.

Susceptibility to radio frequency interference is substantially eliminated and security is enhanced because a wireless connection between the cellular telephone and the microphone and speaker is not used,

Further, the cellular telephone cable assembly is less bulky, cumbersome, and inconvenient to use than contemporary headsets and their associated cable assemblies

The term “sound” as used herein can refer to acoustic sound and can also refer to electrical or other signals that are representative of acoustic sound. Thus, it can be said that sound is communicated though the cable assembly, even when referring to electrical signals.

Embodiments described above illustrate, but do not limit, the invention. It should also be understood that numerous modifications and variations are possible in accordance with the principles of the present invention. Accordingly, the scope of the invention is defined only by the following claims.

1. A cable assembly for a cellular telephone, the cable assembly comprising:
at least one earpiece configured to be received into a conchae of an ear and configured to be held in place by at least one anatomical structure of the conchae;
at least one speaker in acoustic communication with the earpiece(s); and
a cable configured to facilitate electrical communication of signals representative of sound from a cellular telephone to the speaker(s).

2. The cable assembly as recited in claim 1, further comprising a microphone and wherein the cable is configured to communicate a signal representative of sound from the microphone to the cellular telephone.

3. The cable assembly as recited in claim 1, further comprising a microphone that is removably attachable to the cable.

4. The cable assembly as recited in claim 1, wherein the earpiece comprises an arcuate rib having upper and lower ends and a generally straight rib attached to the upper and lower ends of the arcuate rib.

5. The cable assembly as recited in claim 1, wherein the earpiece has a generally D-shaped configuration.

6. The cable assembly as recited in claim 1, wherein the earpiece is configured to be captured by protrusions of the conchae.

7. The cable assembly as recited in claim 1, wherein the earpiece comprises an upper lobe and a lower lobe and wherein the crus and the antihelix of the ear cooperate to capture upper lobe and the tragus and antitragus cooperate to capture lower lobe.

8. The cable assembly as recited in claim 1, wherein the earpiece comprises an arcuate rib and the antihelix and the antitragus cooperate to capture arcuate rib.

9. The cable assembly as recited in claim 1, further comprising an extension attached to the earpiece and configured to extend into an ear canal, wherein the speaker is in acoustic communication with an extension of the earpiece.

10. The cable assembly as recited in claim 1, further comprising acoustic tubing via which the speaker is in acoustic communication with the earpiece.

11. The cable assembly as recited in claim 1, wherein the earpiece(s) comprise two earpieces.

12. The cable assembly as recited in claim 1, wherein the earpiece(s) comprise two earpieces and wherein each earpiece has a dedicated speaker.

13. The cable assembly as recited in claim 1, wherein the earpiece(s) comprise two earpieces and wherein each earpiece has a dedicated speaker so as to facilitate stereo listening.

14. The cable assembly as recited in claim 1, further comprising a connector configured to attach the cable to the cellular telephone.

15. The cable assembly as recited in claim 1, wherein the cable comprises two portions that are connectable to one another via connectors.

16. A cellular telephone system comprising:
a cellular telephone;
at least one earpiece configured to be received into a conchae of an ear and configured to be held in place by at least one anatomical structure of the conchae;
at least one speaker in acoustic communication with the earpiece(s); and
a cable configured to facilitate electrical communication of signals representative of sound from a cellular telephone to the speaker(s).

17. A cable assembly for a music player, the cable comprising:
two earpieces, each earpiece configured to be received into a conchae of an ear and configured to be held in place by at least one anatomical structure of the conchae;
at least one speaker in acoustic communication with each earpiece so as to facilitate stereo listening; and
a cable configured to facilitate electrical communication of signals representative of sound from a music player to each speaker.

18. The cable assembly as recited in claim 17, wherein the earpiece comprises an arcuate rib having upper and lower ends and a generally straight rib attached to the upper and lower ends of the arcuate rib.

19. The cable assembly as recited in claim 17, wherein the earpiece has a generally D-shaped configuration.

20. The cable assembly as recited in claim 17, wherein the earpiece is configured to be captured by protrusions of the conchae.

21. The cable assembly as recited in claim 17, wherein the earpiece comprises an upper lobe and a lower lobe and wherein the crus and the antihelix of the ear cooperate to capture upper lobe and the tragus and antitragus cooperate to capture lower lobe.

22. The cable assembly as recited in claim 17, wherein the earpiece comprises an arcuate rib and the antihelix and the antitragus cooperate to capture arcuate rib.

23. The cable assembly as recited in claim 17, further comprising an extension attached to the earpiece and configured to extend into an ear canal, wherein the speaker is in acoustic communication with an extension of the earpiece.

24. The cable assembly as recited in claim 17, further comprising acoustic tubing via which the speaker is in acoustic communication with the earpiece.

25. The cable assembly as recited in claim 17, wherein the earpiece(s) comprise two earpieces.

26. The cable assembly as recited in claim 17, wherein the earpiece(s) comprise two earpieces and wherein each earpiece has a dedicated speaker.

27. The cable assembly as recited in claim 17, wherein the earpiece(s) comprise two earpieces and wherein each earpiece has a dedicated speaker so as to facilitate stereo listening.

28. The cable assembly as recited in claim 17, further comprising a connector configured to attach the cable to the cellular telephone.

29. The cable assembly as recited in claim 17, wherein the cable comprises two portions that are connectable to one another via connectors.

30. A music player system comprising:
a music player;
two earpieces, each earpiece configured to be received into a conchae of an ear and configured to be held in place by at least one anatomical structure of the conchae;
at least one speaker in acoustic communication with each earpiece so as to facilitate stereo listening; and
a cable configured to facilitate communication of sound from the music player to each earpiece.

31. A universal cable assembly for a personal electronic device, the universal cable assembly comprising:
at least one earpiece configured to be received into a conchae of an ear and configured to be held in place by at least one anatomical structure of the conchae;
at least one speaker in acoustic communication with the earpiece(s);
a cable configured to facilitate communication of signals representative of sound from a cellular telephone to the speaker(s);
a microphone removably attachable to the cable; and
wherein the universal cable assembly is suitable for use with cellular telephones and music players.
